(19) United States
(12) Patent Application Publication
(10) Pub. No.: US 2023/0329494 A1
(43) Pub. Date: Oct. 19, 2023

(54) Elrow

(71) Applicants: Robert J. HAY, Benicia, CA (US); Jacqueline M. HAY, Benicia, CA (US)

(72) Inventors: Robert J. HAY, Benicia, CA (US); Jacqueline M. HAY, Benicia, CA (US)

(21) Appl. No.: 17/803,267

(22) Filed: Apr. 14, 2022

(51) Int. Cl. A47L 9/06; A01G 20/47

(52) U.S. Cl. CPC A47L 9/0693; A01G 20/47

(57) ABSTRACT

“THE ELBOW” is an “ACUTE ANGLE REDUCER” that connects to the end of any Commercial Leaf Blower i.e. Electrical, Gas, or Battery powered. “THE ELBOW” has a larger diameter at the inlet, than at the exit. When installed, It allows the operator to blow debris from behind trees, shrubs, plants, etc., while standing stationary facing landscaping. “THE ELBOW” can be made of any material.

### BACKGROUND OF THE INVENTION

By way of background, presently, there's no piece of equipment that assists the operator in removing debris from behind trees, shrubs, plants, etc., allowing the operator to stand in a stationary position facing landscaping.

### SUMMARY OF THE INVENTION

It's accordingly one object of the present invention to allow the operator to remove debris from trees, shrubs, plants, etc., while standing stationary facing landscaping.

Another object of the present invention is the time saved by removing debris with the absence of movement.

### BRIEF DESCRIPTION OF THE DRAWING

In order that the invention be more fully comprehended, it will now be described, by way of example, with reference to the accompanying drawing. It is to be understood that the phraseology, or terminology, employed is for the purpose of description only and not of limitation.

FIG. 1 is a “SIDE VIEW” of the “ELBOW” being attached, from the larger diameter inlet to the end of any Commercial Leaf Blower tube. (To have a firm, secure fitting, any Rubber Window Seal, found at any hardwood store, wrapped around the end of the larger diameter inlet of “THE ELBOW”, will suffice. When not in use, “THE ELBOW” can be attached to the Commercial Leaf Blower tube, by way of any Velcro Fastener Strips, found at any hardwood store, if desired.)

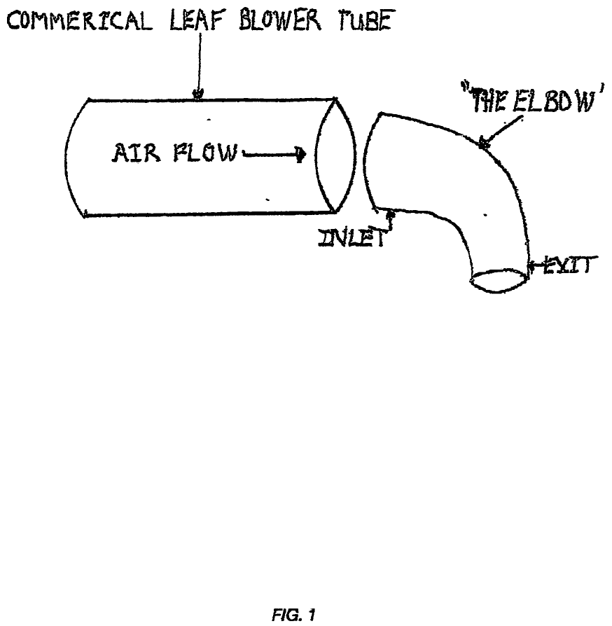

1. We claim as our invention, the “THE ELBOW”. “THE ELBOW” can be made of any material. “THE ELBOW”, which is an “ACUTE ANGLE REDUCER”, connects to the outlet end of any Commercial Leaf Mower i.e. Electrical, Gas, or Battery powered. The larger diameter inlet connects to the Commercial Leaf Blower, while the smaller diameter is at the exit. The reduction in diameter increases the speed of the air, thereby increasing the force of the leaf blower. “THE ELBOW” aspect, of the invention, allows the operator to blow debris from behind trees, shrubs, plants, etc., while standing stationary facing landscaping.
